(19) United States
(12) Patent Application Publication
(10) Pub. No.: US 2025/0377906 A1
(43) Pub. Date: Dec. 11, 2025

(54) SYSTEMS AND METHODS FOR AI ASSISTANT INTEGRATION ON MOBILE

(71) Applicant: Salesforce, Inc., San Francisco, CA (US)

(72) Inventors: Stephen GOLDBERG, Frisco, TX (US); Andrew MANGANO, Sunnyvale, CA (US); Jean Elie BOVET, Neuchatel (CH); Abigail SIGLER, San Francisco, CA (US); Eric ROMERO, Oceanside, CA (US); Stephen COYNER, Seattle, WA (US); Kristen MURAMOTO, Amsterdam (NL); Saket AGARWAL, Fremont, CA (US); Swati CHILAKALA, San Ramon, CA (US); Scotland PETERS, San Ramon, CA (US); Tanya SAARVA, Boulder, CO (US); Chuxiong WU, Livermore, CA (US)

(73) Assignee: Salesforce, Inc., San Francisco, CA (US)

(21) Appl. No.: 18/740,220

(22) Filed: Jun. 11, 2024

(51) Int. Cl. G06F 9/451; G06F 21/31; H04L 51/02

(52) U.S. Cl. CPC G06F 9/451; G06F 21/31; H04L 51/02

(57) ABSTRACT

Disclosed herein are mobile device, method, and computer program product embodiments for an improved integrated mobile AI assistant. The mobile device may launch a mobile application including an integration component, where the integration component is in communication, through the mobile application, with a data service and a user interface (UI) service. The integration component may receive a response including data and a data type from the data service generated by a large language model responsive to a natural language query. The integration component may customize an interface at the integration component using a rendering configuration received from the UI service to display the data, the rendering configuration generated by decomposing the data type into a predefined type.

### BACKGROUND

One or more implementations relate to the field of mobile application integration, and more specifically to a modified and improved integrated mobile AI assistant.

### BRIEF DESCRIPTION OF THE DRAWINGS

The accompanying drawings are incorporated herein and form a part of the specification.

FIG. 1 illustrates an exemplary environment, according to aspects of the present disclosure.

FIG. 2A depicts an exemplary interface for integrating an AI assistant with a mobile application, according to aspects of the present disclosure.

FIG. 2B depicts an exemplary interface for using the AI assistant via a chat interface, according to aspects of the present disclosure.

FIG. 2C depicts an exemplary interface for using the AI assistant via a chat interface, according to aspects of the present disclosure.

FIG. 3 illustrates a flowchart diagram of an exemplary method for using an integrated AI assistant, according to aspects of the present disclosure.

FIG. 4 illustrates a flowchart diagram of an exemplary method for launching additional mobile applications, according to aspects of the present disclosure.

FIG. 5 illustrates a block diagram of an exemplary computer system for implementing one or more aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for AI assistant integration on mobile.

The proliferation of artificial intelligence has led to numerous advances in the ability of systems to analyze data and generate predictions. However, many of these systems are designed to work with desktop or laptop computers, with access to larger screens. As a result, a device with a smaller screen, such as a mobile phone or tablet, may be limited in terms of data it can usefully display to a user.

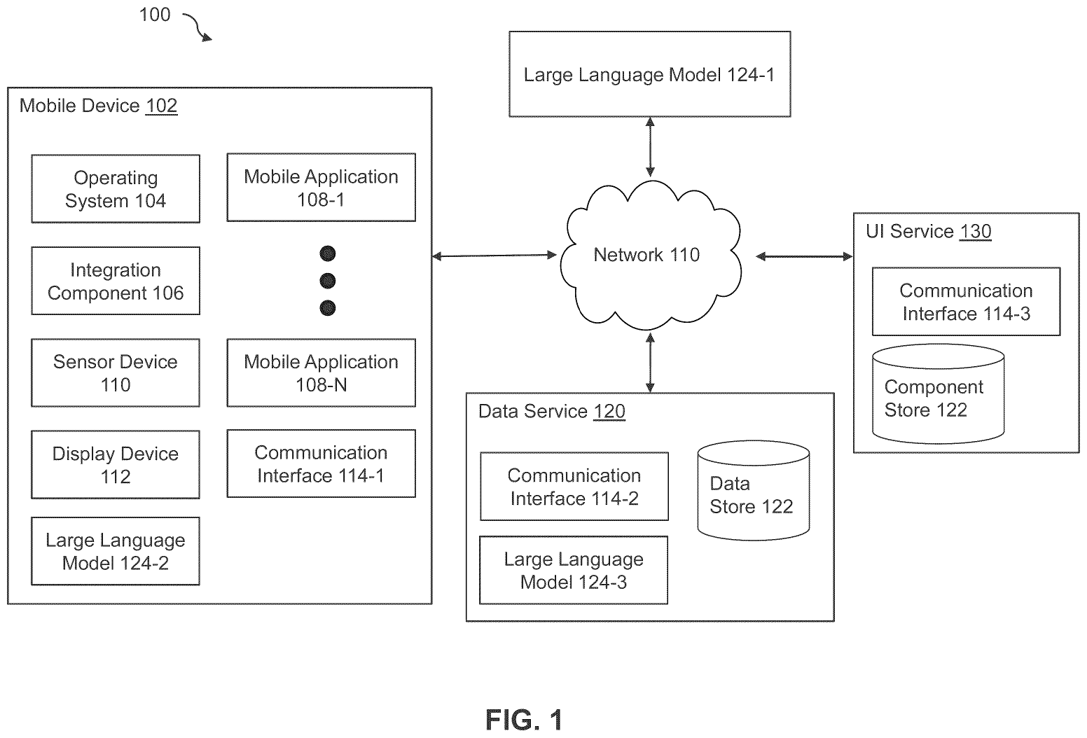

FIG. 1 illustrates an exemplary environment 100, according to embodiments of the present disclosure. Environment 100 may include mobile device 102, network 110, data service 120, large language model 124-1, and UI service 130.

Network 110 may be any type of computer or telecommunications network capable of communicating data, for example, a local area network, a wide-area network (e.g., the Internet), or any combination thereof. The network may include wired and/or wireless segments. In some embodiments, network 110 may be a secure network. In some embodiments, mobile device 102 may reside within network 110. In some embodiments, mobile device 102 may reside outside network 110.

LLM 124 may be a machine learning model used to perform various tasks. LLM 124 may be configured using any machine learning architecture. In some embodiments, LLM 124 may be built using a transformer architecture. LLM 124 may be trained to perform natural language processing tasks such as text summarization, language translation, and speech recognition. LLM 124 may be interacted with via a chatbot interface. For example, LLM 124 may receive natural language query and generate a response. In some embodiments, the response may be natural language, a structured payload, or a combination thereof. Including a structured payload may be beneficial to increase processing speeds on the client device. In some embodiments, interactions with LLM 124 may be via a command line interface (e.g., headless). LLM 124 may be deployed across various locations at network 110. For example, LLM 124 may be a standalone instance deployed on network 110 (e.g., LLM 124-1). As will be discussed in more detail below, LLM 124 may be deployed at mobile device 102 or data service 120 (e.g., LLM 124-2 and LLM 124-3 respectively).

LLM 124 may be trained to receive a prompt and generate a response. The prompt may be multi-modal. For example, the prompt may include text, video, audio, image, or any combination thereof. The prompt may also include information about the sender. For example, the prompt may include information about mobile device 102 such as manufacturer, model, year, IMSI, IMEI, and phone number. The prompt may also include an ID associated with integration component 106 and an identifier associated with mobile application 108. LLM 124 may use this information to tailor a response. For example, LLM 124 may insert a username associated with mobile application 108 into the response in order to personalize it. LLM 124 may be configured to predict a response based on the prompt. LLM 124 may generate the entire response, or part of the response. For example, LLM 124 may be enabled to retrieve data, and include the retrieved data within a response. In some embodiments, the data may be formatted within a natural language response. In some embodiments, the data may be structured data. For example, the data may be in a CSV, JSON, or XML structure. In some embodiments, LLM 124 may alter the format of the data. For example, LLM 124 may be trained to retrieve a value from a JSON structure and insert it within the response. In some embodiments, LLM 124 may be trained to send the data in its stored format. For example, LLM 124 may send the JSON structure within the response. This may be beneficial for the receiving device (e.g., mobile device 102) to render the data.

LLM 124 may be configured to query public and private sources to formulate a response. For example, LLM 124 may access publicly available information (e.g., the internet) to include within a response. Additionally, LLM 124 may access private information. As will be discussed in more detail, data service 120 may function as a back-end system for an application or service on network 110. For example, data service 120 may be a customer relationship management system, and therefore store data regarding customer accounts. Here, LLM 124 may include data service's 120 data within its response. For example, LLM 124 may query a database or other storage device at data service 120, and include the retrieved information within its response.

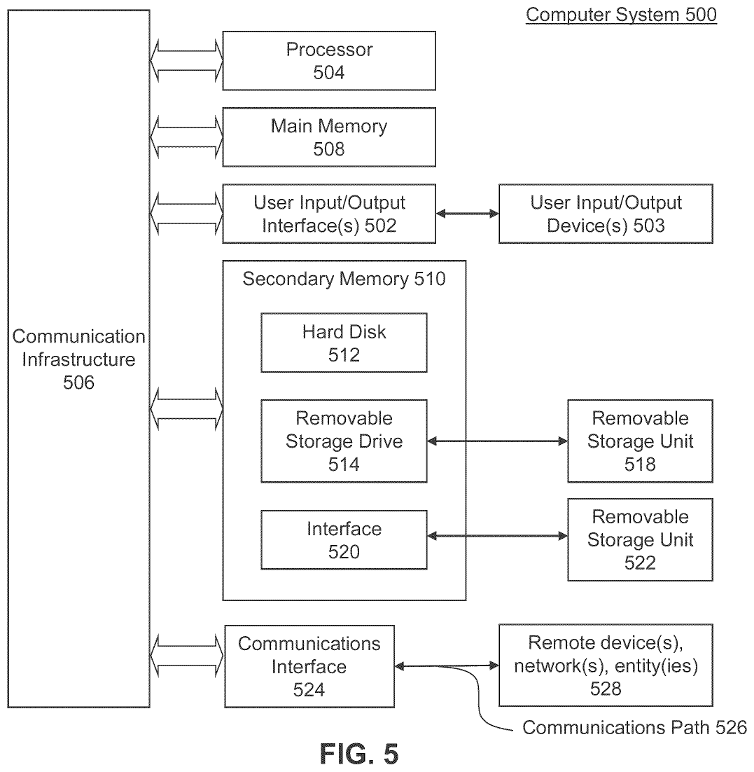

Mobile device 102 may be any computing device. In some embodiments, mobile device 102 may be a smartphone or tablet. Mobile device 102 may be configured to communicate with other entities on network 110. Mobile device 102 may be a computer system such as computer system 500 described with reference to FIG. 5. Mobile device 102 may be a client system such as a desktop workstation, laptop or notebook computer, netbook, tablet, smart phone, and/or other computing device that may be using an enterprise computing system. Although a single mobile device 102 is depicted, environment 100 may include any number of mobile devices 102.

Mobile device 102 may include operating system 104, integration component 106, mobile application 108, sensor device 110, display device 112, communication interface 114, and LLM 124-2. Display device 112 may be a screen to display information at mobile device 102. Display device 112 may include input mechanisms such as one or more buttons. In some embodiments, display device 112 may be a touch screen interface configured to receive touch-based inputs.

Communications interface 114 may be configured to communicate with entities on network 110. For example, communications interface 114-1 may allow mobile device 102 to communicate with LLM 124-1, data service 120, and UI service 130, via network 110. Communications interface 114 may comprise any suitable network interface capable of transmitting and receiving data, such as, for example a modem, an Ethernet card, a communications port, or the like. Communications interface 114 may be able to transmit data using any wireless transmission standard such as, for example, Wi-Fi, Bluetooth, cellular, or any other suitable wireless transmission.

Operating system 104 may be any operating system to manage hardware and software resources on mobile device 102. Operating system 104 may allow integration component 106 and mobile application 108 to utilize hardware resources (e.g., CPU, RAM, storage) at mobile device 102. Operating system 104 may further allow integration component 106 and mobile application 108 to utilize components such as sensor device 110. Operating system 104 may further allow integration component 106 and mobile application 108 to utilize communication interface 114 in order to send and receive data via network 110. Operating system 104 may further allow for inter-application communication. For example, operating system 104 may allow integration component 106 to communicate with mobile application 108, and vice versa. Operating system 104 may be further configured to allow a first mobile application 108-1 to communicate with a second mobile application 108-2.

Sensor device 110 may be any sensor configured to gather data about mobile device 102, its environment, or both. Sensor device 110 may include any of, but is not limited to a camera, microphone, proximity sensor, accelerometer, gyroscope, inertial motion unit, ambient light sensor, compass, barometer, fingerprint scanner, and depth sensor. Sensor device 110 may collect data, including, but not limited to GPS data, image data, video data, audio data, accelerometer data, gyroscope data, barometer data, proximity data, ambient light data, magnetometer data, and LIDAR data.

Sensor device 110 may be utilized by integration component 106 and/or mobile application 108. In some embodiments, operating system 104 may provide integration component 106 and mobile application 108 access to sensor device 110. For example, mobile application 108 may be configured to send image data. Mobile application 108 may include a feature (e.g., button) that when interacted with, requests access to mobile device's 102 camera (e.g., sensor device 110). In some embodiments, mobile application 108 may request permission from operating system 104 to access the camera. Once activated, the camera may be used to collect data (e.g., pictures and video) that is input to mobile application 108.

Mobile application 108 may be any software application installed on mobile device 102. For example, mobile device 102 may download mobile application 108 via network 110. Mobile device 102 may include any number of mobile apps 108 (e.g., mobile application 108-1-mobile application 108-N). Mobile application 108 may be used to access data at data service 120. For example, mobile application 108 may be a text editor configured to access documents stored at data service 120. In some embodiments, mobile application 108 may be an analytics application that provides analysis of data stored at data service 120. For example, a business may generate and store data (e.g., transactions, inventory, personnel files, and finances) at data service 120. Here, mobile application 108 may connect a user to the data at data service 120. For example, a mobile application 108 user may be able to navigate through data stored at data service 120 via mobile application 108.

Mobile application 108 may utilize components of mobile device 102 such as operating system 104, sensor device 110, display device 112, and communication interface 114. Mobile application 108 may integrate with integration component 106 to leverage AI capabilities.

Integration component 106 may be used to integrate an AI assistant in order to optimize and improve mobile application 108. Integration component 106 may be configured to communicate with multiple mobile applications 108. Integration component 106 may be an application installed on mobile device 102. In some embodiments, integration component 106 may be downloaded and be included within mobile application 108. In some embodiments, integration component 106 may be an application separate from mobile application 108. Integration component 106 and mobile application 108 may interface via an application programming interface (API). The API may define various functions that allow mobile application 108 to communicate integration component 106. Integration component 106 may include a configuration file including a setting to list mobile applications 108 to integrate with.

Integration component 106 may be configured to interface with LLM 124. Integration component 106 may establish a connection to LLM 124. In some embodiments, LLM 124 may exist as a separate entity on network 110 (e.g., LLM 124-1). In some embodiments, LLM 124 may exist locally on mobile device 102 (e.g., LLM 124-2). In some embodiments, LLM 124 may exist at data service 120 (e.g., LLM 124-3).

Integration component 106 may be configured to connect to LLM 124. For example, integration component 106 may include a setting to define the location of LLM 124. For example, an on device location may be specified (e.g., LLM 124-2) or an IP address of a network-based LLM 124 may be provided (e.g., LLM 124-1, LLM 124-3). The setting may be defined in the configuration file associated with integration component 106.

In some embodiments, mobile device 102 may include LLM 124-2. As stated above, LLM 124 may be a machine learning model used to perform various tasks such as natural language processing. Here, integration component 106 may utilize LLM 124-2 to interpret and perform functions for mobile application 108. For example, mobile application 108 may attempt to browse data at data service 120. As opposed to manually browsing through a file structure at data service 120, mobile application 108 may use integration component 106. This is beneficial, because it may be infeasible for a user on a smartphone (e.g., mobile device 102) to manually navigate a file structure. Instead, integration component 106 may be leveraged to retrieve and summarize data so that it may be usefully displayed at mobile device 102.

Here, integration component 106 may be displayed as a chatbot interface within mobile application 108. A user may input a query to the chatbot interface. The query may be a function they may typically perform manually on mobile application 108. For example, if a user wishes to view a file associated with mobile application 108, as opposed to manually navigating a file structure, the user may input a request such as, “Summarize File ABC.” Integration component 106 may forward this request to LLM 124, which may interpret the query and provide a response (e.g., summary of the file). As will be discussed in more detail below, integration component 106 may be further used to customize an interface at mobile device 102 based on the response.

Integration component 106 may further be configured to launch other mobile applications 108 on mobile device 102. For example, integration component 106 may launch an email application, instant messaging application, image capturing application, a video capturing application, an audio capturing application, a web browsing application, or navigation application. Integration component 106 may communicate with operating system 104 to launch the other mobile application 108. For example, operating system 104 may determine whether integration component 106 has permission to cause the other mobile application 108 to be launched. Operating system 104 may approve or deny integration component's 106 request.

Integration component 106 may launch other mobile applications 108 in various circumstances. For example, integration component 106 may include interface elements (e.g., buttons, symbol) that when interacted with, launch other mobile applications 108. For example, integration component 106 may include a camera symbol that when pressed, launches a camera application at mobile device 102. As an additional example, integration component 106 may include a microphone symbol that when pressed, launches an audio recording application at mobile device 102.

In some embodiments, integration component 106 may launch a mobile application 108 based on a response from LLM 124. In some embodiments, LLM 124 may augment a response with one or more actions. An action may include a recommendation to launch another mobile application 108. For example, LLM 124 may receive a prompt, and formulate a response. The prompt may include data and a data type. LLM 124 may input the data and data type, and in addition to predicting a response, may predict a type of mobile application 108 that may correlate to the data and data type. LLM 124 may recommend mobile apps 108 based off of the data. For example, LLM 124 may include an association between keywords within the data and mobile applications 108. For example, the data (e.g., prompt) input to LLM 124 may include keywords such as “camera” or “video.” LLM 124 may include an association between words such as “camera” and “video” with image or video capturing applications. As an additional example, LLM 124 may include associations between words such as “directions,” “find,” and “navigate” with navigation applications. LLM 124 may scan the data (e.g., prompt) for keywords and recommend one or more mapped mobile applications 108. LLM 124 may also recommend applications based on the type of data included in the prompt. For example, if an image or video is input to LLM 124, LLM 124 may recommend an image or video capturing application within its response. Additionally, if the prompt includes text data, LLM 124 may recommend a text editor, email application, or instant messaging application to edit and/or share the text. The recommended applications may be included as part of LLM's 124 response to integration component 106.

Integration component 106 may use the recommendation to launch or recommend a second mobile application 108 to the user. For example, integration component 106 may include its own mapping of recommended applications to mobile applications 108 on mobile device 102. For example, integration component 106 may query operating system 104 for a list of installed mobile applications 108. Integration component 106 may map recommendations from LLM 124 to mobile applications 108 installed on mobile device 102. For example, integration component 106 may include a mapping that links image capturing application, recommended by LLM 124 to the camera application (e.g., mobile application 108) installed on mobile device 102.

In some embodiments, mobile device 102 may not have an application corresponding to one recommended by LLM 124. For example, LLM 124 may determine that the data returned to mobile device 102 relates to weather patterns and in response may recommend a weather application. Integration component 106 may request a manifest of installed mobile applications 108 from operating system 104. Integration component 106 may search the manifest for keywords such as “weather.” If a mobile application 108 corresponding to the recommendation can't be located, integration component 106 may recommend downloading a new mobile application 108. For example, integration component 106 may launch a mobile application 108 capable of downloading new mobile applications 108 (e.g., an application marketplace).

LLM 124 may further recommend launching other mobile apps 108 based on interactions with mobile device 102. For example, integration component 106 may track and send LLM 124 user interactions with integration component 106. For example, integration component 106 may track parts of the chatbot interface a user is interacting with, such as, where a user has clicked, data a user has highlighted, copied, pasted, saved, and deleted. Integration component 106 may record and send these interactions for LLM 124. Integration component 106 may generate one or more key value pairings. Each key may be a data element the user interacted with (e.g., a summarized record). Each value may be an action the user performed on the data element (e.g., copy, highlight). Integration component 106 may send one or more key value pairings to LLM 124. LLM 124 may input the interactions (e.g., click, highlight, copy) and the underlying data to make recommendations. For example, LLM 124 may input that a user highlighted and copied the name of a company (e.g., ABC) listed in the response. LLM 124 may recommend a browser application (e.g., mobile application 108) configured to perform an internet search on ABC. In response, the user may interact with the recommendation to launch the recommended application (e.g., mobile application 108-2). In some embodiments, integration component 106 may be configured to communicate data with the launched recommended application (e.g., mobile application 108-2).

Actions from LLM 124 may also include suggested further interactions with integration component 106. For example, a user may request a summary of data at data service 120 via integration component 106. LLM 124 may provide the summary and recommend an action to find similar records or to request the entire record itself, in addition to the summary. The actions described above (e.g., recommended applications, recommended interactions with integration component 106) may be rendered as buttons at integration component 106 within the chatbot interface.

Data service 120 may be configured to access and manage data on network 110. Data service 120 may be implemented using one or more servers and/or databases. In some embodiments, data service 120 may be implemented using a computing device such as a desktop workstation, laptop or notebook computer, netbook, tablet, smart phone, and/or other computing device. In some embodiments, data service 120 may be implemented as an application in an enterprise computing system and/or a cloud-computing system. In some embodiments, data service 120 may be a computer system such as computer system 500 described with reference to FIG. 5. Data service 120 may communicate with mobile application 108 at mobile device 102 via network 110. Data service 120 may include communication interface 114-2, data store 122, and LLM 124-3.

Data store 122 may be implemented using a memory device and store data relating to data service 120. For example, data service 120 may be a human resources application, and data store 122 may store all the data used by data service 120 such as employee records. As another example, data service 120 may be a financial institution, and data store 122 may include financial and accounting records used by data service 120. Data store 122 may be further configured to store account information associated with users of data service 120. For example, a user may have to create an account and perform authentication in order to access data service 120.

Mobile application 108 may be configured to communicate with data service 120. Accordingly, mobile application 108 may include a user account to authenticate a user of mobile application 108 to ensure they have proper access rights to data service 120. For example, if data service 120 is a bank, and mobile application 108 is a banking app, data service 120 may require mobile application 108 to be authenticated prior to granting it access. Authentication may be inputting and validating various kinds of information. For example, authentication mechanisms may use, but are not limited to username, password, fingerprint, facial recognition, voiceprint, security question, or a reverse Turing test. In some embodiments, authentication may involve performing a combination of the authentication mechanisms described above. In some embodiments, the validation may occur at mobile device 102. In some embodiments, validation may occur at data service 120. The user account may further determine what data at data service 120 the account has access to. For example, for the same mobile application 108, a customer account may have access to a first data set at data service 120, and an administrator account may have access to a second set of data at data service 120. Once an account is created, data service 120 may store account details at data store 120 for future authentication.

As discussed above, LLM 124 may be a machine learning model natural language processing tasks. LLM 124-3 may allow for natural language interaction between mobile device 102 and data service 120. As discussed above, LLM 124 may be deployed at a location on network 110. Here, LLM 124 may be deployed as part of data service 120 (e.g., LLM 124-3). Here, integration component 106 may be configured to communicate with LLM 124-3. For example, mobile application 108 may be configured to access and interact with a database at data service 120 (e.g., data store 122). On a larger device such as a desktop computer, data store 122 may be interacted with via SQL queries or using a file browser. However, on a smaller device such as mobile device 102 (e.g., a smartphone), this may be infeasible because of the small screen space. Here, integration component 106 and LLM 124-3 may be leveraged to perform the interactions. For example, as opposed to an SQL query, integration component 106 may display a chatbot interface within mobile application 108, and be connected to data service 120. The chatbot interface at integration component 106 may receive natural language queries or input (e.g., English text). The natural language input may be related to mobile application 108. For example, the input may be a request to view a record at data store 122 used by mobile application 108. The natural language query may be sent to data service 120, and interpreted by LLM 124-3. LLM 124-3 may use: (1) the natural language query; and (2) a source application (e.g., mobile application 108) identifier to create a context for the query.

Sending an identifier of mobile application 108 to LLM 124 is beneficial so that the query may be answered in the context of mobile application 108. As stated above, mobile application 108 may be authenticated with data service 120. This not only provides a level of security with regard to data accessed and communicated, it also allows a user account associated with mobile application 108 to be used. Here, LLM 124 may use the authenticated user account to enforce rules or policies associated with the user account. For example, the user account at mobile application 108 may define what data it may access at data service 120. LLM 124 may apply the rules associated with the user account when generating a response. For example, LLM 124 may include a lookup table defining the type of access each type of user account has. For example, a customer account may have access to a first data set but not a second data set, whereas an administrator account may have access to both the first and second data sets. Here, when LLM 124 receives the query and source application information, it may compare the account in the source application information to a lookup table at data service 120, to determine permissions or restrictions associated with the account. LLM 124 may utilize the permissions when formulating the response. For example, LLM 124 may not provide data from a data set that the account is barred from accessing.

LLM 124-3 may convert the query into an API or function call to interact with data service 120 (e.g., an SQL query). The SQL query may be used to access or otherwise interact with data store 122. For example the record may be retrieved. In some embodiments, the record may be compressed and/or encrypted after retrieval.

In response, LLM 124-3 may generate a response. LLM 124-3 may generate a natural language response. For example, a natural language response may include a summary of the record. In some embodiments, LLM 124-3 may include parts of the data within the response. For example, LLM 124-3 may insert fields from the record, or the entire record within the response. Sending a structured payload (e.g., the entire record) may be beneficial to update mobile device's 102 UI more quickly.

The response (e.g., summary, parts of the record, copy of entire record) may be returned to mobile device 102 via network 110. The summary and the record data itself, or a link to the record may be presented within integration component 106. Once received, integration component 106 may query UI service 130 to determine how integration component 106 should display the information within mobile application 108. As discussed above, mobile devices such as mobile device 102 may have limited screen space. In response, there may be optimal and suboptimal ways to view information to allow for improved case of use.

In some embodiments, integration component 106 may be used to update data at data service 120. For example, a user at mobile device may launch mobile application 108. Mobile application 108 may be configured to integrate with integration component 106. The user may submit a query for mobile application 108, through integration component 106. The query may relate to a database record or other item stored at data service 120. The response may be displayed at integration component 106 within mobile application 108. The user may wish to update the retrieved record. For example, the user may input a request to change the record via the chatbot interface at integration component 106. LLM 124 may receive the request. LLM 124 may be LLM 124-3 at data service 120. Data service 120 may determine whether an account associated with mobile application 108 has permissions to update the record. As stated above, user account information may be sent to data service 120 as part of requests at integration component 106. Here, data service 120 may determine whether the account has permissions to update the record. If the account does not have permission, a message stating the account associated with mobile application 108 lacks permissions may be sent to mobile device 102. If the account has permissions, data service 120 may update the record at data store 122. Data service 120 may then send an acknowledgment. Data service 120 may send the updated data to LLM 124-3. LLM 124-3 may generate a response. In some embodiments, the response may be natural language, such as a summary of the updated data. In some embodiments, the response may be structured data including a copy of the updated data. This may be beneficial to rapidly detect the data structure, and quickly display it within mobile application 108. Data service 120 may then send the response, including the updated data, to mobile device 102. The response may be displayed at integration component 106 within mobile application 108.

UI service 130 may be configured to store and manage UI components corresponding to data associated with data service 120. UI service 130 may be implemented using one or more servers and/or databases. In some embodiments, UI service 130 may be implemented using a computing device such as a desktop workstation, laptop or notebook computer, netbook, tablet, smart phone, and/or other computing device. In some embodiments, UI service 130 may be implemented as an application in an enterprise computing system and/or a cloud-computing system. In some embodiments, UI service 130 may be a computer system such as computer system 500 described with reference to FIG. 5. UI service 130 may communicate with mobile device 102 via network 110.

UI service 130 may include component store 122 to maintain a store of internal mappings that determine UI components to render at mobile device 102 in response to data sent from data service 120. As stated above, mobile device 102 may interact with data service 120 to manage, request, and/or view data. Data at data service 120 may have various types. In order to efficiently view and interact with the data, UI service 130 may store components mapped to data types. UI service 130 may indicate to mobile device 102 which component to render, based on the type of data that mobile device 102 received from data service 120. Component store 122 may use data types to determine UI components. Data types may include primitive types and composite types.

Primitive types may include strings, integers, and Booleans. Primitive types may be further used to create composite data types. Composite data types may include one or more primitive data types grouped together. For example, a composite data type “Contact” may include two primitive data types: (1) a string corresponding to a name; and (2) a string corresponding to an address. In some embodiments, composite data types may include nested composite data types. Citing the “Contact” example above, it may include: (1) a string corresponding to a name; and (2) a composite data type “Address.” The composite data type “Address” may include: (1) a string corresponding to a city; and (2) an integer corresponding to a zip code.

UI service 130 may include a rendering configuration for all data types. Rendering configurations may be used to determine how the mapped data type should be displayed on mobile device 102 by integration component 106. Rendering configuration to data type mappings may be further assigned by mobile application 108. Stated differently, each mobile application 108 may have its own rendering configurations. For example, a first mobile application 108 may have a first renderer for primitive type string, and a second mobile application 108 may have a second renderer for primitive type string. The result being that each mobile application 108 may be able to display the same primitive types in different manners by leveraging integration component 106. Rendering configurations may be created for mobile application 108 via an administrative account associated with mobile application 108. For example, an administrative user may log into mobile application 108, connect to UI service via integration component 106, and manage rendering configurations.

The administrative user may be able to create new composite data types. For example, an administrative user may create a new composite data type for “Customer,” used to hold biographical information of mobile application's 108 customers. The administrative account may define custom renderers for composite data types. For example, “Customer” may be matched with a “Customer” renderer. For composite types without custom renderers, UI service 130 may decompose the data type. Decomposing a data type involves breaking down the data composite data type recursively into its primitive data types.

For example, “Customer” may include: (1) name; (2) email; (3) address; (4) phone number. If “Customer” does not have its own renderer, UI service 130 may decompose “Customer” into the four components, where each may be a primitive type string. Once decomposed, the primitive data type may be rendered using the renderer associated with mobile application's 108 primitive data type renderer. The administrative user may be able to add, delete, and edit renderers associated with mobile application 108.

Integration component 106 may receive rendering configurations from UI service 130. Integration component 106 may match rendering configurations to UI components (e.g., boxes, buttons, checkboxes, cards, date/time, inputs, modals, menus, loading bars, toggle switches, cards, dropdowns, charts, graphs, and tables). The UI components may be native to operating system 104. Integration component 106 may update a user interface at display device 112 using the UI components determined by the rendering configurations from UI service 130. For example, if integration component 106 is used to update data at data service 120, when the updated data is returned, integration component 106 may query and receive a rendering configuration from UI service 130 to display the updated data. The rendering configuration may be used to update the interface at integration component 106.

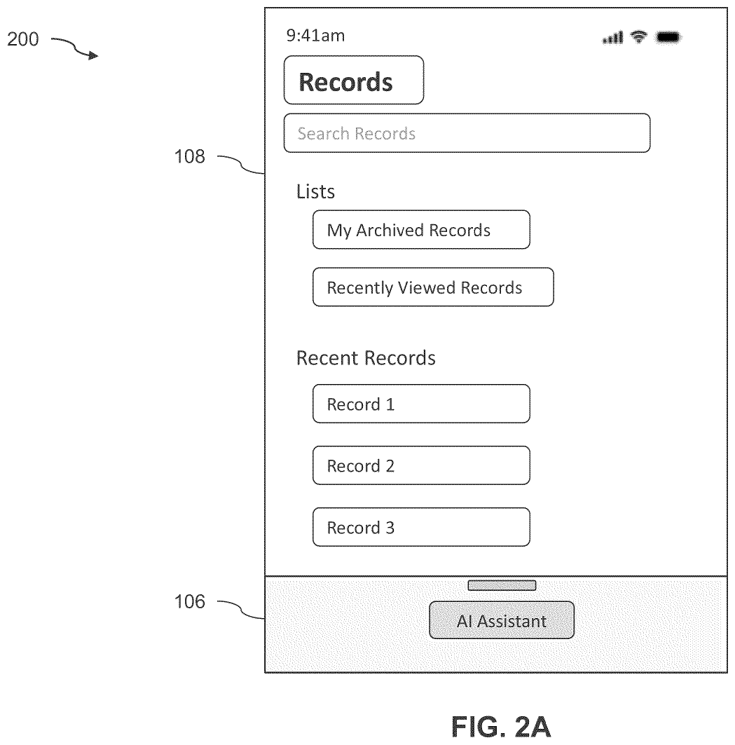

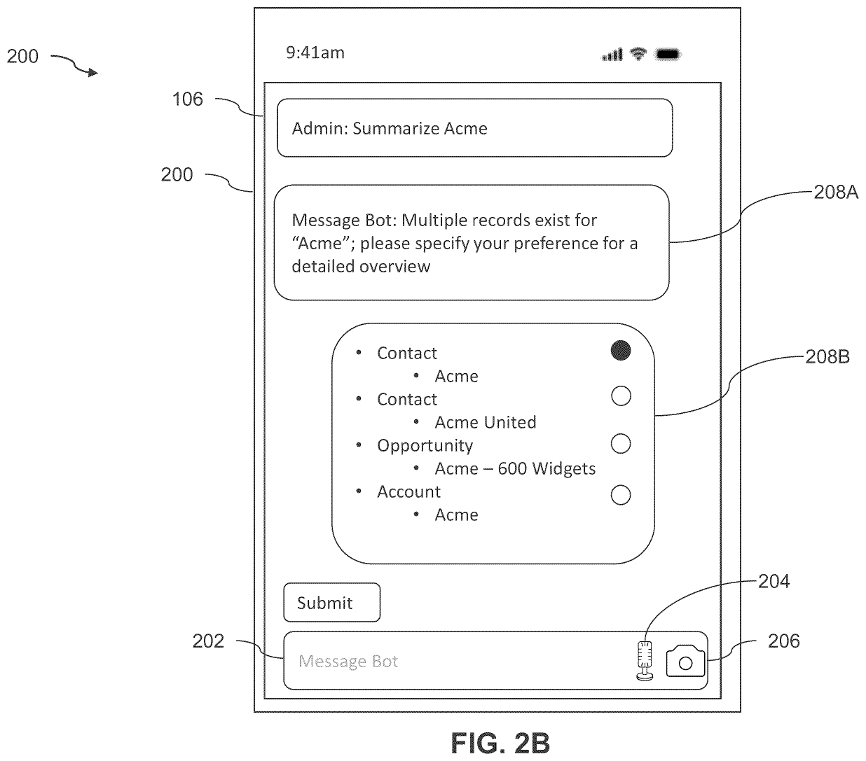

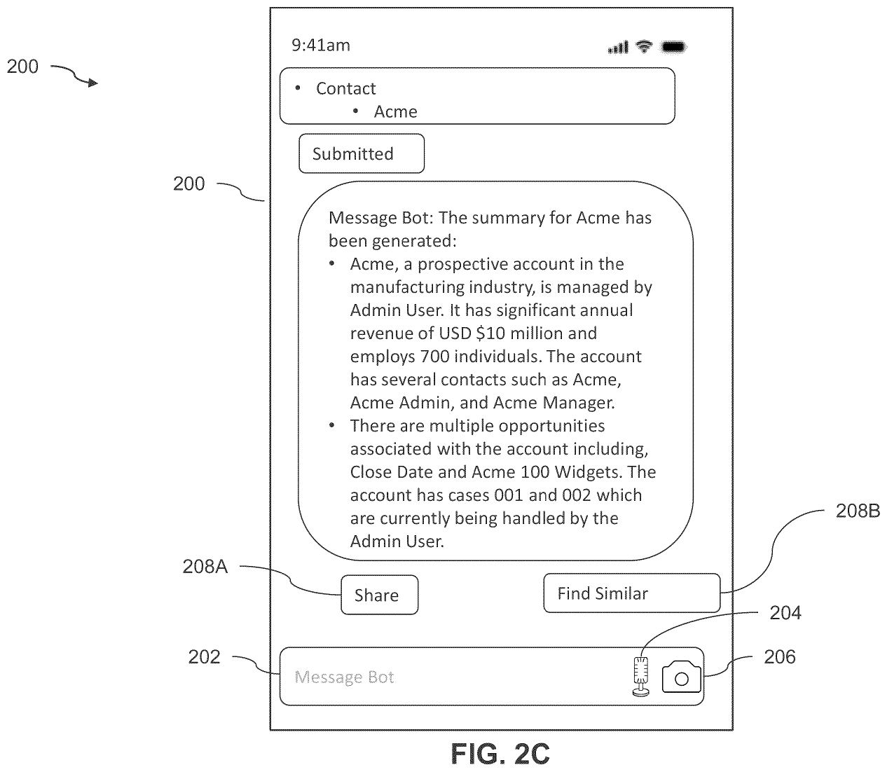

FIG. 2A depicts an exemplary interface 200 for using an integrated AI assistant. Interface 200 may include both mobile application 108 and integration component 106. As discussed above, integration component 106 may be integrated with mobile application 108. For example, mobile application 108 may be used by a database administrator to manage records at data service 120. Therefore, mobile application 108 may display records available for inspection at interface 200. Integration component 106 may be available for use. For example, a user may click on or swipe up an interface component associated with integration component 106.

FIG. 2B depicts an exemplary interface 200 for using a chatbot at integration component 106 within mobile application 108. For example, FIG. 2B may be displayed when integration component 106 is interacted with at FIG. 2A. As discussed above, integration component 106 may be configured to utilize an AI assistant. The AI assistant may be LLM 124. In some embodiments, this may be accomplished through a chatbot. Integration component 106 may use a chatbot interface to input queries and receive responses. For example, a response may be input related to the function of mobile application 108. For example, a user may input a request such as “Summarize Acme” into the chatbot at integration component 106. LLM 124 may translate the natural language query into a query used by mobile application 108. For example, the input “Summarize Acme” may be converted into a SQL query such as “SELECT*FROM Records WHERE Company_Name=‘Acme’.”

Input to the chatbot may be received at input 202. For example, text may be typed via a keyboard at input 202. Integration component 106 may further include an ability to launch other utilities. For example, integration component 106 may include the ability to activate mobile device's 102 sensor devices 110. For example, microphone 204 may be used to turn on mobile device's 102 microphone (e.g., sensor device 110). In some embodiments, camera 206 may be used to launch mobile device's 102 camera (e.g., sensor device 110). Data captured from sensor device 110 may be input to integration component 106 at input 202.

For example, integration component 106 may receive an interaction with microphone 204. In response, integration component 106 may launch an audio recording application (e.g., mobile application 108) at mobile device 102. Integration component 106 may receive the captured audio and use LLM 124 to convert the captured audio into text. The text may then displayed at input 202. Similarly, integration component 106 may receive an interaction with camera 206. In response, integration component 106 may cause mobile device's 102 image and/or video capture application to be launched. Images and/or video captured maybe received at integration component 106 and sent to input 202.

For example, camera 206 may launch mobile device's 102 camera, and pictures and/or video may be input to integration component 106. Integration component 106 may then send the pictures and/or video data to data service 120. Integration component 106 may interact with operating system 104 to access sensor devices 110. For example, integration component 106 may request access to sensor device 110 from operating system 104.

As depicted in FIG. 2B, the chatbot (e.g., LLM 124) may require further clarification regarding a request. In the example depicted within FIG. 2B, LLM 124 may determine that Acme corresponds to multiple records at data service 120. As a result, LLM 124 may request clarification as to which records the user wishes to access.

Integration component 106 may update interface 200 by communicating with UI service 130. As discussed above, UI service 130 may include internal mappings that determine UI components to render at mobile device 102. A response 208 from LLM 124 may include a data and a data type. For example, response 208A may include the response text as the data and have a corresponding data type string. Here, integration component 106 may query what renderer to use for the received data, data type, and mobile application 108. As discussed above, different mobile applications 108 may use different rendering components. UI service 130 may perform a lookup and respond with the renderer corresponding to the data type for mobile application 108. Integration component 106 may identify the renderer from UI service 130 and use it to update interface 200. As an additional example, response 208A may be structured data such as a JSON structure. Here, integration component 106 may query UI service 130 for a renderer for JSON data associated with mobile application 108. In some embodiments, the data type may be a custom data structure used within mobile application 108. For example, mobile application 108 and data service 120 may include a custom data structure to create, store, and edit data. Here, UI service 130 may include a renderer for the custom data structure so that integration component 106 may update interface 200 when the custom data structure is included within a response.

FIG. 2C depicts an exemplary interface 200 for using a chatbot at integration component 106. FIG. 2C depicts a response to the request to “Summarize Acme.” FIG. 2C includes actions 208. Actions 208 may be additional actions based on the response from LLM 124. In some embodiments, LLM 124 may send suggested actions for integration component 106 to render. Integration component 106 may include a mapping of actions 208 to responses. For example, LLM 124 may predict that a user of mobile device 102 may wish to share a generated summary. LLM 124 may therefore include a suggested action such as “Share” along with the summary. Integration component 106 may render actions 208 as buttons. For example, action 208A may be a button to share the response. Action 208A may be mapped to a response that may show available utilities to share the response. For example, when action 208A is interacted with, integration component 106 may show available utilities or mobile applications 108 on mobile device 102 capable of sharing the response. In some embodiments, the available utilities may be an email application or an instant messaging application.

In some embodiments, actions 208 may include further interaction with LLM 124. For example, LLM 124 may predict, based off the response, that a user at mobile device 102 may request further information or clarification. For example, LLM 124 may predict that a user may wish to see items similar to those requested. Here, LLM 124 may return include a suggested action such as “Find Similar.” Integration component 106 may render the suggested action as action 208B. Action 208B may be mapped to a response that sends a message to LLM 124 to identify similar items. When action 208B is interacted with, integration component 106 may automatically populate input 202 with a natural language request corresponding to action 208. For example, integration component 106 may populate input 202 with “Find Similar Records” and send the request to LLM 124.

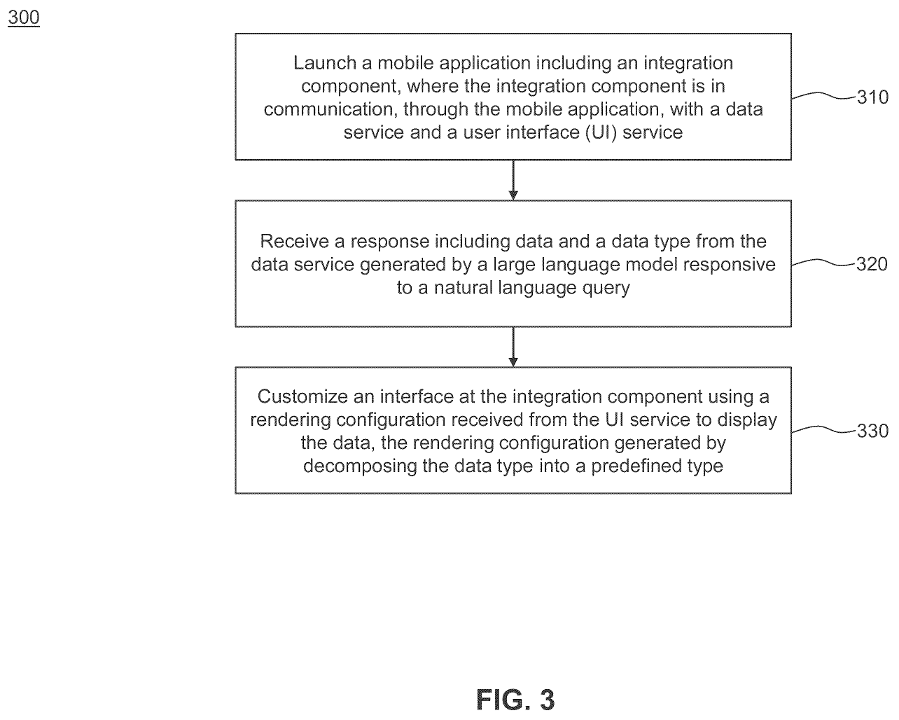

FIG. 3 illustrates a flowchart diagram of an exemplary method 300 for AI assistant integration on mobile according to embodiments of the present disclosure.

As shown in FIG. 3, the method begins at step 310 by launching, at a mobile device, a mobile application (e.g., mobile application 108) including an integration component (e.g., integration component 106). The integration component may be in communication, through the mobile application, with a data service and a user interface (UI) service. In some embodiments, the mobile application may be mobile application 108 and the integrated integration component may be integration component 106. In some embodiments, the data service may be data service 120 and the UI service may be UI service 130. The integration component and mobile application may be in connection with the data and UI service via a network such as network 110.

In step 320, integration component 106 receives a response including data and a data type from the data service generated by a large language model responsive to a natural language query. In some embodiments, the response may be natural language. In some embodiments, the response may be structured data (e.g., a JSON structure). In some embodiments, the response may include natural language and structured data. The LLM may be LLM 124-3 at data service 120. The response may be sent via network 110. As stated above, integration component 106 may include a chatbot interface that facilitates communication with data service 120. The chatbot interface may allow for natural language queries and responses with LLM 124. The query may relate to the function of the mobile application (e.g., mobile application 108). For example, mobile application 108 may be used to view or interact with database records associated with data service 120. For example, the records may be kept at data store 122. Using this example, the query may have been a request to view a record, such as “Show me Acme Co.'s Q1 performance.” LLM 124 may translate the natural language query into a functional query used by data service 120. For example, if the query relates to a database, the natural language query may be converted into an SQL query.

In step 330, integration component 106 customizes an interface at the integration component using a rendering configuration received from the UI service to display the data. The UI service may be UI service 130. The rendering configuration may be generated by decomposing the data type into a predefined type. The customized interface may be displayed via display device 112. As stated above, UI service 130 may include a component store 122 to store mappings between data types and UI components. UI service 130 may further include mappings between data types and UI components for specific mobile applications 108. For example, two mobile applications 108 may each have different UI components for the same data type. In some embodiments, integration component 106 may decompose the data type into a predefined type and send it to UI service 130. The predefined data type may be a primitive data type or a composite data type. In some embodiments, integration component 106 may send the data and data type to UI service 130, and UI service 130 may decompose the data into one or more predefined types. UI service 130 may return a rendering configuration for integration component 106 to use. Integration component 106 may determine UI components (e.g., boxes, buttons, checkboxes, cards, date/time, inputs, modals, menus, loading bars, toggle switches, cards, dropdowns, charts, graphs, and tables) based on the rendering configuration from UI service 130.

As stated above, data at data service 120 may have a type. The type may be used to define the format of the data, not only for use within mobile applicant 108 and integration component 106, but also for UI service 130. Since mobile device 102 may have a smaller screen than a standard desktop or laptop computer, there may be more efficient ways to display certain kinds of data. As opposed to using standard layout for all data, here, each data type may be assigned a layout or rendering configuration to be displayed within. The configuration may be optimized for use within a device having a smaller screen (e.g., mobile device 102).

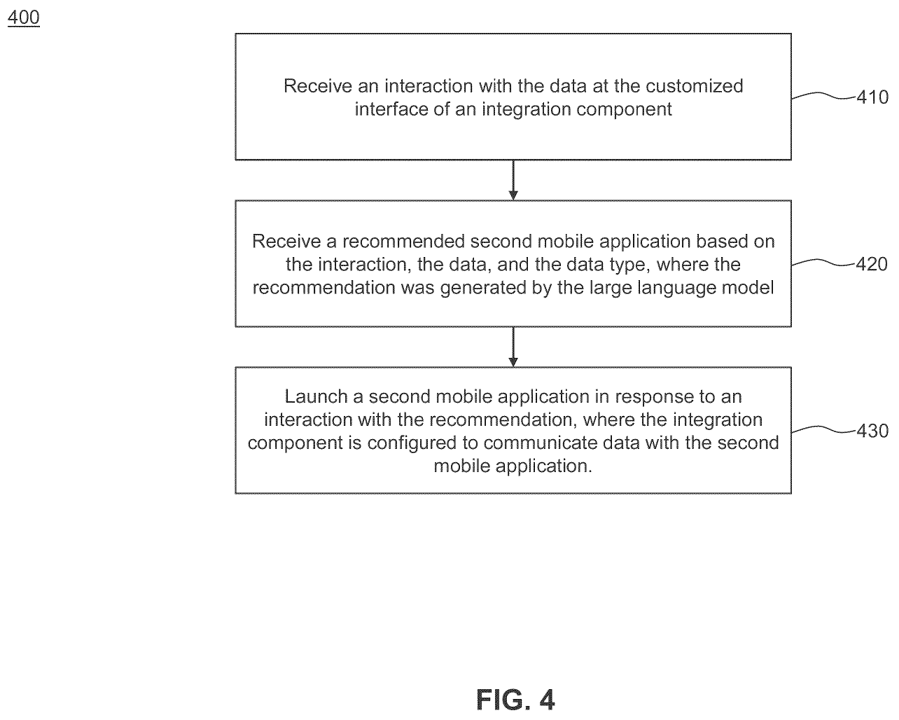

FIG. 4 illustrates a flowchart diagram of an exemplary method for launching additional mobile applications, according to embodiments of the present disclosure. At 410, integration component 106 receives an interaction with the data at the customized interface. Integration component 106 may be customized according to rendering configurations received from UI service 130. The interaction may occur at display device 112 and include where a user has clicked, data a user has highlighted, copied, pasted, saved, and deleted. The interaction may further include the underlying data interacted with. For example, the interaction may include that part of a response from the LLM was interacted with.

At 420, integration component 106 receives a recommended second mobile application based on the interaction, the data, and the data type, where the recommendation was generated by the large language model. The large language model may be LLM 124. Integration component 106 may receive the recommendation based on sending the interactions captured to LLM 124. As discussed above, LLM 124 may be trained to input one or more user interactions and predict a mobile application in response. The second mobile application may be a mobile application 108 installed at mobile device 102.

At 430, integration component 106 launches a second mobile application in response to an interaction with the recommendation, where the integration component is configured to communicate data with the second mobile application. As discussed above, the recommendation may be displayed as a UI element (e.g., a button) within integration component 106. Here, a user may click on the recommendation in order to launch the second mobile application (e.g., mobile application 108). The second mobile application may also be integrated with integration component 106 to send and receive data. The second mobile application may be an email application, instant messaging application, image capturing application, a video capturing application, an audio capturing application, a web browsing application, or a navigation application.

It will be understood that the order of the above steps are merely exemplary, and the steps can be rearranged in any appropriate manner. For example, in embodiments, the envoy may perform local rate limiting prior to mapping the header and conducting a global rate limiting check. Additionally, more or fewer steps may be included in the exemplary method consistent with the disclosure.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random-access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A mobile device, comprising:
a memory; and
at least one processor coupled to the memory and configured to:
launch, at a mobile device, a mobile application including an integration component, wherein the integration component is in communication, through the mobile application, with a data service and a user interface (UI) service;
receive, at the integration component, a response including data and a data type from the data service generated by a large language model responsive to a natural language query; and
customize, by the integration component, an interface at the integration component using a rendering configuration received from the UI service to display the data, the rendering configuration generated by decomposing the data type into a predefined type.

2. The mobile device of claim 1, wherein the at least one processor is further configured to:
receive, at the integration component, an interaction with the data at the customized interface;
receive, at the integration component, a recommended second mobile application based on the interaction, the data, and the data type, wherein the recommendation was generated by the large language model; and
launch, by the integration component, a second mobile application in response to an interaction with the recommendation, wherein the integration component is configured to communicate data with the second mobile application.

3. The mobile device of claim 1, wherein the second mobile application is at least one of an email application, instant messaging application, an image capturing application, a video capturing application, an audio capturing application, a web browsing application, or a navigation application.

4. The mobile device of claim 1, wherein the customized interface includes a chatbot interface and wherein the at least one processor is further configured to:
send a natural language request to update the received data, where the natural language request was input to the chatbot interface;
receive, at the integration component, a response including updated data and a data type from the data service generated by a large language model responsive to the natural language request; and
update, by the integration component, the interface at the integration component using the rendering configuration from the UI service to display the updated data.

5. The mobile device of claim 1, wherein the at least one processor is further configured to:
authenticate a user associated with the mobile application via an authentication mechanism executed by the integration component.

6. The mobile device of claim 5, wherein the authentication mechanism is configured to use a username, password, fingerprint, facial recognition, voiceprint, security question, or a reverse Turing test.

7. The mobile device of claim 1, wherein the integration component is configured to input sensor data collected by the mobile device, the sensor data including GPS data, image data, video data, audio data, accelerometer data, gyroscope data, barometer data, proximity data, ambient light data, magnetometer data, and LIDAR data.

8. A method, comprising:
launching, at a mobile device, a mobile application including an integrated integration component, wherein the integration component is in communication, through the mobile application, with a data service and a user interface (UI) service;
receiving, at the integration component, a response including data and a data type from the data service generated by a large language model responsive to a natural language query; and
customizing, by the integration component, an interface at the integration component using a rendering configuration received from the UI service to display the data, the rendering configuration generated by decomposing the data type into a predefined type.

9. The method of claim 8, further comprising:
receiving, at the integration component, an interaction with the data at the customized interface;
receiving, at the integration component, a recommended second mobile application based on the interaction, the data, and the data type, wherein the recommendation was generated by the large language model; and
launching, by the integration component, a second mobile application in response to an interaction with the recommendation, wherein the integration component is configured to communicate data with the second mobile application.

10. The method of claim 9, wherein the second mobile application is at least one of an email application, instant messaging application, an image capturing application, a video capturing application, an audio capturing application, a web browsing application, or a navigation application.

11. The method of claim 8, wherein the customized interface includes a chatbot interface and wherein method further comprises:
send a natural language request to update the received data, where the natural language request was input to the chatbot interface;
receive, at the integration component, a response including updated data and a data type from the data service generated by a large language model responsive to the natural language request; and
updating, by the integration component, the interface at the integration component using the rendering configuration from the UI service to display the updated data.

12. The method of claim 8, further comprising:
authenticating a user associated with the mobile application via an authentication mechanism executed by the integration component.

13. The method of claim 12, wherein the authentication mechanism is configured to use a username, password, fingerprint, facial recognition, voiceprint, security question, or a reverse Turing test.

14. The method of claim 8, wherein the integration component is configured to input sensor data collected by the mobile device, the sensor data including GPS data, image data, video data, audio data, accelerometer data, gyroscope data, barometer data, proximity data, ambient light data, magnetometer data, and LIDAR data.

15. A non-transitory computer-readable device having instructions stored thereon that, when executed by at least one computing device, cause the at least one computing device to perform operations comprising:
launching, at a mobile device, a mobile application including an integrated integration component, wherein the integration component is in communication, through the mobile application, with a data service and a user interface (UI) service;
receiving, at the integration component, a response including data and a data type from the data service generated by a large language model responsive to a natural language query; and
customizing, by the integration component, an interface at the integration component using a rendering configuration received from the UI service to display the data, the rendering configuration generated by decomposing the data type into a predefined type.

16. The non-transitory computer-readable device of claim 15, wherein the operations further comprise:
receiving, at the integration component, an interaction with the data at the customized interface;
receive, at the integration component, a recommended second mobile application based on the interaction, the data, and the data type, wherein the recommendation was generated by the large language model; and
launching, by the integration component, a second mobile application in response to an interaction with the recommendation,
wherein the integration component is configured to communicate data with the second mobile application; and
wherein the second mobile application is at least one of an email application, instant messaging application, an image capturing application, a video capturing application, an audio capturing application, a web browsing application, or a navigation application.

17. The non-transitory computer-readable device of claim 15, wherein the customized interface includes a chatbot interface and the operations further comprise:
sending a natural language request to update the received data, where the natural language request was input to the chatbot interface;
receiving, at the integration component, a response including updated data and a data type from the data service generated by a large language model responsive to the natural language request; and
updating, by the integration component, the interface at the integration component using the rendering configuration from the UI service to display the updated data.

18. The non-transitory computer-readable device of claim 15, wherein the operations further comprise:
authenticating a user associated with the mobile application via an authentication mechanism executed by the integration component.

19. The non-transitory computer-readable device of claim 15, wherein the authentication mechanism is configured to use a username, password, fingerprint, facial recognition, voiceprint, security question, or a reverse Turing test.

20. The non-transitory computer-readable device of claim 15, wherein the integration component is configured to input sensor data collected by the mobile device, the sensor data including GPS data, image data, video data, audio data, accelerometer data, gyroscope data, barometer data, proximity data, ambient light data, magnetometer data, and LIDAR data.
